(19) United States
(12) Patent Application Publication
(10) Pub. No.: US 2006/0277779 A1
(43) Pub. Date: Dec. 14, 2006

(54) Mounting template

(76) Inventor: Alan Bauer, Medina, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/988,149

(22) Filed: Nov. 12, 2004

(51) Int. Cl. B43L 7/00

(52) U.S. Cl. 33/566

(57) ABSTRACT

A template having a plurality of holes at predetermined distances oriented in such a way that the template provides holes to drill fastening holes for a first accessory, such as a towel bar, and holes to drill fastening holes for a second accessory, such as a paper holder. A first line of holes and a second line of holes are aligned at a right angle such that in operation, the template is held in a first position when drilling for the first accessory and the template is held in a second position when drilling for the second accessory. The second position is obtained by rotating the template 90° from the first position. The template also includes a pair of bubble gauges which are oriented at a right angle with respect to each other.

### FIELD OF AND BACKGROUND OF THE INVENTION

The invention relates to a mounting template and more specifically to a mounting template and method for mounting accessories, such as a towel bar and paper holder in an expedited manner.

In today's house construction industry, houses are being built at a rapid pace. House builders require tools that help increase the speed and accuracy of their work. In the bathroom in particular, it becomes tedious and time-consuming to mount accessories such as towel bars and toilet paper holders. Most bathroom designs include at least one towel bar and a toilet paper holder. Typically, to mount a towel bar or paper holder, one must first determine the location on the wall to hang the accessory posts. Then, a pair of holes for the mounting fasteners must be drilled at a precise distance from each other and horizontally level. This requires measuring, marking, leveling several times to ensure the mounting holes are level and the correct distance apart. Add to this that there are usually multiple bathrooms in a single house. As a result, the process of mounting towel bars and toilet paper holders is a tedious and time-consuming process.

### SUMMARY OF THE INVENTION

The template of the present invention allows for quicker and more precise mounting of towel bars and paper holders. The template includes a plurality of holes or marking devices at predetermined distances oriented in such a way that the template provides holes or marking devices to drill or mark fastening holes for a first accessory, such as a towel bar, and holes or marking devices to drill or mark fastening holes for a second accessory, such as a paper holder. A first line of holes and a second line of holes are aligned at a right angle such that in operation, the template is held in a first position when drilling for the first accessory and the template is held in a second position when drilling for the second accessory. The second position is obtained by rotating the template 90° from the first position. The template also includes a pair of level indicators, such as bubble gauges, which are oriented at a right angle with respect to each other.

Numerous other advantages and features of the present invention will become readily apparent from the following detailed description of the invention and the embodiments thereof, from the claims and from the accompanying drawings.

### BRIEF DESCRIPTION OF THE DRAWINGS

The invention as well as embodiments and advantages thereof are described below in greater detail, by way of example, with reference to the drawings in which:

FIG. 1 is a perspective view of the template in accordance with an embodiment of the present invention.

### DETAILED DESCRIPTION OF THE INVENTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

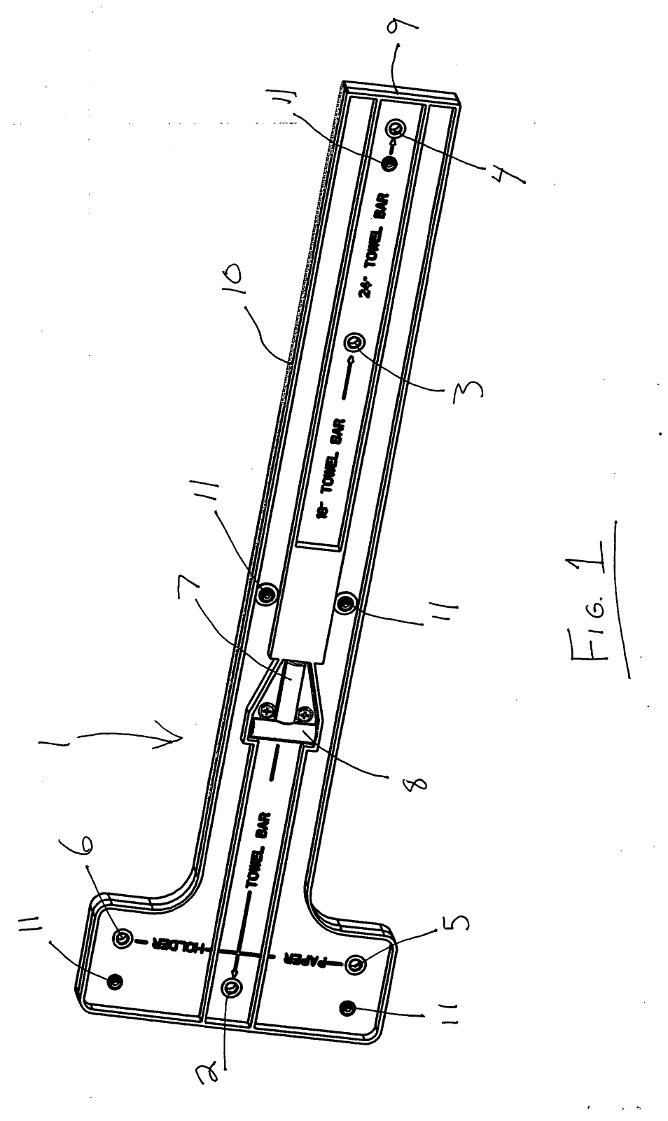

FIG. 1 shows a template 1 in accordance with an embodiment of the present invention. The template 1 of FIG. 1 is designed specifically for mounting a towel bar (18″ or 24″) and paper holder, however, the template 1 may be modified for use in mounting any desired accessory. The selection of towel bar and paper holder is not critical and should not be viewed as limiting the scope of the invention.

The template 1 has a T-shaped frame made from a hard clear plastic, although other shapes and materials are within the scope of the present invention. The template has a plurality of holes disposed therein where at least two of the holes form a first line and at least two of the holes form a second line. The first and second lines are at right angles to one another.

In the embodiment shown in FIG. 1, the template 1 has a towel bar base hole 2, an 18 inch towel bar hole 3 and a 24 inch towel bar hole 4. If a user wishes to mount an 18 inch towel bar, holes 2 and 3 would be used as they correspond to an 18 inch towel bar and are a predetermined 18 inches apart. If a user wishes to mount a 24 inch towel bar, holes 2 and 4 would be used as they correspond to a 24 inch towel bar and are a predetermined 24 inches apart. The distances between holes correspond to the accessories mounting needs and not necessarily to the length or width of the accessory.

At one end of the template 1 are paper holder holes 5, 6. Paper holder holes 5 and 6 are a predetermined distance apart (approximately 6 inches) from each other corresponding to a paper holder. Holes 2, 3, 4, which correspond to the towel bars, form a first line that is at a right angle to a second line formed by holes 5, 6, which correspond to the paper holder. In other embodiments, a particular hole may fall within both the first line and the second line.

All holes 2, 3, 4, 5, 6 are large enough to allow a drill bit or other marking instrument such as a pencil to pass through. Furthermore, instead of holes, marking devices may be employed such as small pins or pointed projections extending from the back side of the template. These marking devices, when pressed against the wall would mark the location where fastening holes should be drilled. As used herein, marking includes not only making marks on a wall, such as with a pencil or marker, but also includes making indentations, drilling or creating holes in the wall.

The template 1 also includes a pair of bubble gauges 7, 8 oriented at a right angle to each other, although other types of leveling devices are within the scope of the present invention. Although the bubble gauges 7, 8 are shown adjacent to each other, each bubble gauge may be positioned at different locations on the template 1 as long as they remain at right angles to each other. The towel bar bubble gauge 7 allows a user to know when the towel bar holes 2, 3, 4 are horizontally level. Similarly, the paper holder bubble gauge 8 allows a user to know when paper holder holes 5, 6 are horizontally level.

In the template 1 of FIG. 1, the paper holder holes 5, 6 are located at a predetermined distance from end surface 9. Specifically, the paper holder holes 5, 6 are 24 inches from end surface 9. This allows a user to locate each paper holder 24 inches from the floor, which is the typical industry standard height for paper holders.

Also included on template 1 are ruler markings 10. This provides additional functionality to the template 1. Furthermore, the template 1 has gripping pads 11 positioned at various places on the backside of the template. The rubber gripping pads 11 allow the user to press the template 1 against the mounting wall without damaging the wall while also preventing the template 1 from undesirably sliding or moving while the template 1 is being used.

In one embodiment of the invention, the template 1 is used to mount a first accessory, such as a 24 inch towel bar by first choosing a location on a mounting wall. The template 1 is then lifted to the desired location on the wall, pressed against the wall until the gripping pads 11 make contact with the wall, and held by the user such that towel bar holes 2 and 4 align horizontally level. The user can them make small adjustments based on the bubble gauge 7 reading to ensure that towel bar holes 2, 4 are horizontally level. Once the towel bar holes 2, 4 are level, the user may simply drill holes in the wall by placing the drill bit through holes 2 and 4 to create fastening holes in the wall. The user may also simply mark the wall using other types of marking instruments such as a pencil by inserting the pencil into each of holes 2, 4 and making a mark on the wall. The template 1 can then be removed and fastening holes drilled at the marked locations.

The same template 1 can also be used to mount a second discrete accessory, such as a paper holder. To do so, the user would rotate the template 1 by 90° such that end surface 9 is located below paper holder holes 5, 6. The user would then determine the desired location of the paper holder and place the template 1 against the wall at that location such that the end surface 9 abuts the floor beneath the desired location of the paper holder. By abutting the end surface 9 of the template 1 against the floor, the user is assured that the paper holder will be located 24 inches above the floor, as is the industry standard.

The template 1, with gripping pads 11 pressed against the wall, is adjusted slightly to level the paper holder holes 5, 6 based on the readings of bubble gauge 8. Once the bubble gauge 8 indicates that holes 5, 6 are horizontally level, the user may then drill the fastening holes in the wall by placing the drill bit through holes 5, 6. Alternatively, the user may mark the wall by placing a different type of marking instrument (other than a drill) though each hole 5, 6. With the wall marked, the template 1 may be removed and the fastening holes may then be drilled at the marked locations.

As can be seen, the template 1 of the present invention allows for quicker mounting of different accessories without the need for multiple tools.

The above description of the invention has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A mounting template comprising:
a frame having a plurality of holes disposed within said frame;
wherein at least two of said plurality of holes form a first line and are a predetermined distance from each other corresponding to a first accessory;
wherein at least two of said plurality of holes form a second line and are a predetermined distance from each other corresponding to a second accessory;
wherein said first line and said second line are aligned at a right angle.

2. The mounting template of claim 1, wherein said second line of holes is located at a predetermined distance from an end surface of said template corresponding to a desired mounting height of said second accessory.

3. The mounting template of claim 1, wherein said template further comprises:
a first level indicator disposed on said frame; and
a second level indicator disposed on said frame and oriented at a right angle to said first level indicator.

4. The mounting template of claim 1, wherein said template further comprises a gripping pad disposed on a back surface of said frame.

5. The mounting template of claim 1, wherein said template further comprises ruler markings on said frame.

6. The mounting template of claim 1, wherein said first line of holes includes holes disposed within said frame at a predetermined distance from each other corresponding to a third accessory.

7. The mounting template of claim 1, wherein said first line of holes includes holes disposed within said frame at predetermined distances from each other corresponding to multiple accessories.

8. The mounting template of claim 1, wherein said frame is T-shaped and made from clear plastic.

9. A method of marking mounting holes for a plurality of accessories comprising the steps of:
pressing a mounting template having a plurality of holes against a wall, said mounting template oriented in a first direction;
marking said wall with a marking instrument by placing said marking instrument through a first line of holes in said mounting template corresponding to a first accessory;
pressing said mounting template against said wall, said mounting template oriented in a second direction, wherein said second direction is at a right angle to said first direction;
marking said wall with said marking instrument by placing said marking instrument through a second line of holes in said mounting template corresponding to a second accessory.

10. The method of claim 9 wherein said second line of holes is located at a predetermined distance from an end surface of said template corresponding to a desired mounting height of said second accessory.

11. The method of claim 9 further comprising the step of abutting an end of said template against a floor prior to marking through said second line of holes.

12. The method of claim 9 further comprising the steps of:
leveling said first line of holes horizontally using a first level indicator attached to said template; and
leveling said second line of holes horizontally using a second level indicator attached to said template,
wherein said first level indicator and said second level indicator are oriented at a right angle to each other.

13. A mounting template comprising:
a frame having a plurality of marking devices extending from a back side of said frame;
wherein at least two of said plurality of marking devices form a first line at a predetermined distance from each other corresponding to a first accessory;
wherein at least two of said plurality of marking devices form a second line at a predetermined distance from each other corresponding to a second accessory;
wherein said first line of marking devices and said second line of marking devices are aligned at a right angle.

14. The mounting template of claim 13, wherein said second line of marking devices is located at a predetermined distance from an end surface of said template corresponding to a desired mounting height of said second accessory.

15. The mounting template of claim 13, wherein said template further comprises:
a first level indicator disposed on said frame; and
a second level indicator disposed on said frame and oriented at a right angle to said first level indicator.

16. The mounting template of claim 13, wherein said first line of marking devices includes marking devices extending from the back side of said frame at predetermined distances from each other corresponding to multiple accessories.

17. A method of marking mounting holes for a plurality of accessories comprising the steps of:
placing a mounting template against a wall, said mounting template oriented in a first direction;
marking said wall by pressing a first line of marking devices against said wall, said first line of marking devices extend from a back side of said mounting template and correspond to a first accessory;
placing said mounting template against said wall, said mounting template oriented in a second direction, wherein said second direction is at a right angle to said first direction;
marking said wall by pressing a second line of marking devices against said wall, said second line of marking devices extend from a back side of said mounting template and correspond to a second accessory.

18. The method of claim 17 further comprising the steps of:
leveling said first line of marking devices horizontally using a first level indicator attached to said template; and
leveling said second line of marking devices horizontally using a second level indicator attached to said template,
wherein said first level indicator and said second level indicator are oriented at a right angle to each other.

19. The method of claim 17 wherein said second line of marking devices is located at a predetermined distance from an end surface of said template corresponding to a desired mounting height of said second accessory.

20. The method of claim 17 further comprising the step of abutting an end of said template against a floor prior to pressing said second line of marking devices.
